(19) United States
(12) Patent Application Publication
(10) Pub. No.: US 2026/0184391 A1
(43) Pub. Date: Jul. 2, 2026

(54) VEHICLE WITH ROOF SPOILER MEMBER

(71) Applicant: SUBARU CORPORATION, Tokyo (JP)

(72) Inventors: Hiroshi SHIMAKATA, Tokyo (JP); Takuya ARAI, Tokyo (JP); Katsuo KOBAYASHI, Tokyo (JP)

(73) Assignee: SUBARU CORPORATION, Tokyo (JP)

(21) Appl. No.: 19/432,668

(22) Filed: Dec. 24, 2025

(30) Foreign Application Priority Data
Dec. 27, 2024 (JP) 2024-231449

(51) Int. Cl. B62D 35/00

(52) U.S. Cl. CPC B62D 35/007

(57) ABSTRACT

A vehicle with a roof spoiler member includes a roof spoiler member and a facing surface member. The roof spoiler member is fixed to a vehicle body of the vehicle at a rear side of a roof of the vehicle body so as to be separated from the roof of the vehicle body and a vehicle body rear surface. The facing surface member is provided on the vehicle body. The facing surface member is configured to protrude from the vehicle body rear surface above a rear window of the vehicle body. The facing surface member is configured to, when removing snow adhering to the vehicle body rear surface or when preventing snow adhesion to the vehicle body rear surface, move from a state of protruding from the vehicle body rear surface and be stored in the vehicle body rear surface.

### CROSS-REFERENCE TO RELATED APPLICATIONS

The present application claims priority from Japanese Patent Application No. 2024-231449 filed on Dec. 27, 2024, the entire contents of which are hereby incorporated by reference.

### BACKGROUND

The disclosure mainly discloses a vehicle with a roof spoiler member.

Some vehicles include a roof spoiler member to reduce an air resistance (see Japanese Unexamined Patent Application Publication (JP-A) No. H10-024869 and JP-A No. 2009-286158).

In general, the roof spoiler member extends along a vehicle width direction of a vehicle body on a rear side of a roof of the vehicle body of a vehicle.

### SUMMARY

An aspect of the disclosure provides a vehicle with a roof spoiler member. The vehicle includes the roof spoiler member and a facing surface member. The roof spoiler member is fixed to a vehicle body of the vehicle at a rear side of a roof of the vehicle body so as to be separated from the roof of the vehicle body and a vehicle body rear surface. The facing surface member is provided on the vehicle body. The facing surface member is configured to protrude from the vehicle body rear surface above a rear window of the vehicle body. The facing surface member is configured to, when removing snow adhering to the vehicle body rear surface or when preventing snow adhesion to the vehicle body rear surface, move from a state of protruding from the vehicle body rear surface and be stored in the vehicle body rear surface.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a diagram illustrating airflow and an air resistance over and under a vehicle.

FIG. 2 is a schematic diagram of a vehicle with a roof spoiler member according to an embodiment of the disclosure.

FIG. 3 is a schematic diagram illustrating a state in which a kick member in FIG. 2 protrudes from a vehicle body rear surface.

FIG. 4 is a schematic diagram illustrating a state in which the kick member in FIG. 2 is stored in the vehicle body rear surface.

FIG. 5 is a table illustrating an example of a relationship between a mode setting of the vehicle and a content of control of the kick member in the embodiment.

FIG. 6 is a schematic diagram illustrating airflow over the vehicle body rear surface in a normal mode in which the air resistance is reduced.

FIG. 7 is a schematic diagram illustrating a state in which snow adheres to the vehicle body rear surface in the normal mode.

FIG. 8 is a schematic diagram illustrating airflow over the vehicle body rear surface in a snow removal mode.

FIG. 9 is a flowchart illustrating an example of control of the kick member that is executed by a control device in FIG. 2.

FIG. 10 is a table illustrating an example of a relationship between a mode setting of a vehicle and a content of control of a kick member in a modified example.

### DETAILED DESCRIPTION

As in JP-A No. 2009-286158, the roof spoiler member may be fixed to a vehicle body so as to be separated from a vehicle body rear surface of the vehicle body. Airflow is generated over and under the roof spoiler member separated from the vehicle body rear surface of the vehicle body.

Since the roof spoiler member as disclosed in JP-A No. 2009-286158 is provided, the airflow over a roof of the vehicle body is less likely to be drawn onto the vehicle body rear surface of the vehicle body after passing through a rear edge of the roof, and is more likely to flow toward the rear of the vehicle body while maintaining the flow over the roof. As a result, the air resistance of the vehicle body is reduced.

However, in JP-A No. 2009-286158, the airflow over the roof of the vehicle body is less likely to be drawn onto the vehicle body rear surface of the vehicle body, and as a result, airflow under a floor of the vehicle body is more likely to be drawn onto the vehicle body rear surface of the vehicle body. During traveling during snow falling or during traveling on a snowy road, snow is blown up by the airflow under the floor, and the snow carried by the airflow under the floor is likely to adhere to the vehicle body rear surface of the vehicle body. When the snow adheres to a rear window on the vehicle body rear surface, rearward visibility decreases. When the snow adheres to a rear light on the vehicle body rear surface, visibility of the vehicle body from behind decreases.

In this manner, what is desired for the vehicle having the roof spoiler member is to achieve both reducing the air resistance by the roof spoiler member and reducing snow adhesion to the vehicle body rear surface of the vehicle body. What is desired for a vehicle is to achieve both reduction in air resistance and reduction in snow adhesion to the vehicle body rear surface, which are countermeasures contradictory to each other from an aerodynamical point of view.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

An outline of the embodiment is described, and then airflow around the vehicle body and basic air resistance are described, and examples are given of the vehicle having the roof spoiler member, a configuration and a control system of a kick member, a movable control state of the kick member, overbody airflow when the kick member protrudes from the vehicle body rear surface, snow adhesion to the vehicle body rear surface, overbody airflow when the kick member is stored in the vehicle body rear surface, and mode control.

### Outline

Certain vehicles include a roof spoiler member. By providing the roof spoiler member to the vehicle body, an air resistance of the vehicle can be reduced.

However, since the roof spoiler member is provided on the vehicle body, snow may adhere to the vehicle body rear surface.

For the countermeasure, in one embodiment of the disclosure, a movable facing surface member is provided on the vehicle body along with the roof spoiler member. The roof spoiler member is fixed to the vehicle body at a rear side of a roof of the vehicle body of the vehicle so as to be separated from the roof of the vehicle body and the vehicle body rear surface. The facing surface member is movable in such a manner as to protrude from the vehicle body rear surface above the rear window of the vehicle body. The facing surface member is movable between a state of protruding from the vehicle body rear surface and a state of being stored in the vehicle body rear surface.

When reducing the air resistance of the vehicle body, the facing surface member protrudes from the vehicle body rear surface such that a depression angle of a facing surface that faces a lower surface of the roof spoiler member becomes a first control depression angle. Accordingly, the air resistance of the vehicle can be reduced.

In contrast, when removing snow adhering to the vehicle body rear surface, the facing surface member moves such that a depression angle of the facing surface becomes a second control depression angle, which is a depression angle greater than the first control depression angle. Accordingly, the vehicle can generate an airflow that flows from top to bottom along the rear window and the snow adhering to the vehicle body rear surface can be removed.

### Description of Airflow Around Vehicle Body and Basic Air Resistance

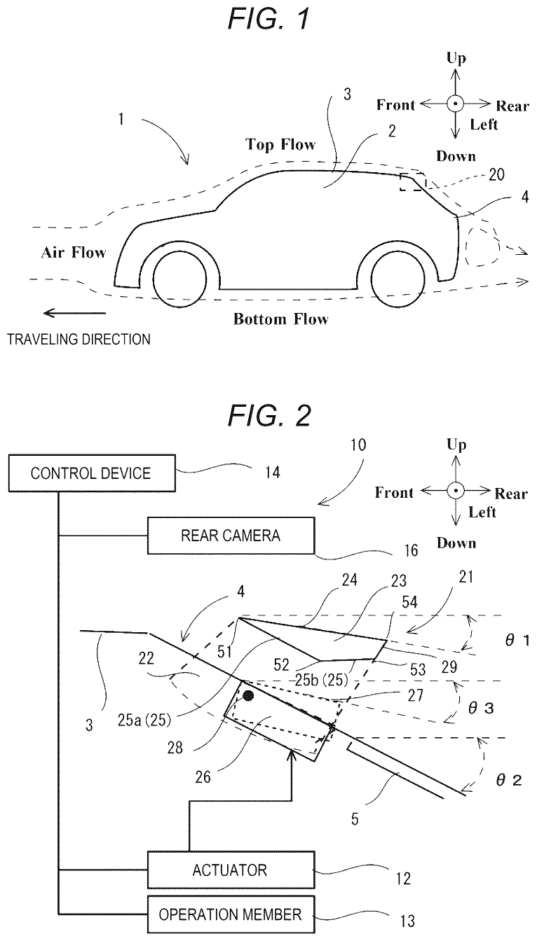

FIG. 1 is a diagram illustrating airflow and an air resistance over and under a vehicle 1.

Hereinafter, up, down, left, right, front and rear will be used as illustrated in FIG. 1. A vehicle width direction is a direction along a left-right direction.

The vehicle 1 illustrated in FIG. 1 includes a vehicle body 2. When the vehicle 1 travels, airflow (“Air Flow”) is generated around the vehicle 1. Overbody airflow (“Top Flow”) on the vehicle body 2 flows rearward from a front surface of the vehicle body 2 along a roof 3. Underbody airflow (“Bottom Flow”) under the vehicle body 2 flows rearward while passing under the vehicle body 2. The overbody airflow and the underbody airflow join on the rear side of a vehicle body rear surface 4 of the vehicle body 2 and flow toward the rear of the vehicle body 2. At this time, vortices are generated on the rear side of the vehicle body rear surface 4, as illustrated in FIG. 1. The vortices on the rear side of the vehicle body rear surface 4 are generally generated when a part of the overbody airflow flows around the rear side of the vehicle body rear surface 4. Since such vortices are generated on the rear side of the vehicle body rear surface 4, a force to pull the vehicle body 2 rearward is generated, and the air resistance of the vehicle body 2 is increased.

In order to prevent the vortices on the rear side of the vehicle body 2, the vehicle 1 may be provided with a roof spoiler member. As illustrated by a dashed-line frame 20 in FIG. 1, many vehicle bodies 2 having a vehicle body shape illustrated in FIG. 1 are provided with a roof spoiler member at a rear end portion of the roof 3. By providing the roof spoiler member, after passing through a rear edge of the roof 3 of the vehicle body 2, the overbody airflow over the roof 3 of the vehicle body 2 is less likely to flow downward toward the rear side of the vehicle body rear surface 4 of the vehicle body 2, and the overbody airflow is likely to flow toward the rear of the vehicle body 2 while maintaining a flow over the roof 3. As a result, the air resistance of the vehicle body 2 is reduced.

However, as a result of the overbody airflow over the roof 3 of the vehicle body 2 being less likely to flow downward toward the rear side of the vehicle body rear surface 4 of the vehicle body 2, the underbody airflow under the floor of the vehicle body 2 is likely to flow upward toward the rear side of the vehicle body rear surface 4 of the vehicle body 2. During traveling during snow falling or during traveling on a snowy road, the snow is blown up by the underbody airflow under the floor of the vehicle body 2, and is likely to adhere to the vehicle body rear surface 4 of the vehicle body 2 as illustrated in FIG. 7, which will be described later. When the snow adheres to a rear window, which will be described later, on the vehicle body rear surface 4, rearward visibility decreases. When snow adheres to a rear light, which will be described later, on the vehicle body rear surface 4, visibility of the vehicle body 2 from behind decreases.

In this manner, what is desired for the vehicle 1 is not only to reduce the air resistance by providing the roof spoiler member, but also to prevent snow adhesion to the vehicle body rear surface 4 of the vehicle body 2. What is desired for the vehicle 1 is to achieve both reduction in air resistance and reduction in snow adhesion to the vehicle body rear surface 4 which are countermeasures contradictory to each other from an aerodynamical point of view.

### Example of Vehicle with Roof Spoiler Member

FIG. 2 is a schematic diagram illustrating the vehicle 1 with a roof spoiler member 21 according to the embodiment of the disclosure.

The vehicle 1 in FIG. 2 includes the roof spoiler member 21, a kick member 26, a rear camera 16, an actuator 12, an operation member 13, and a control device 14. In one embodiment, the kick member 26 may serve as the facing surface member.

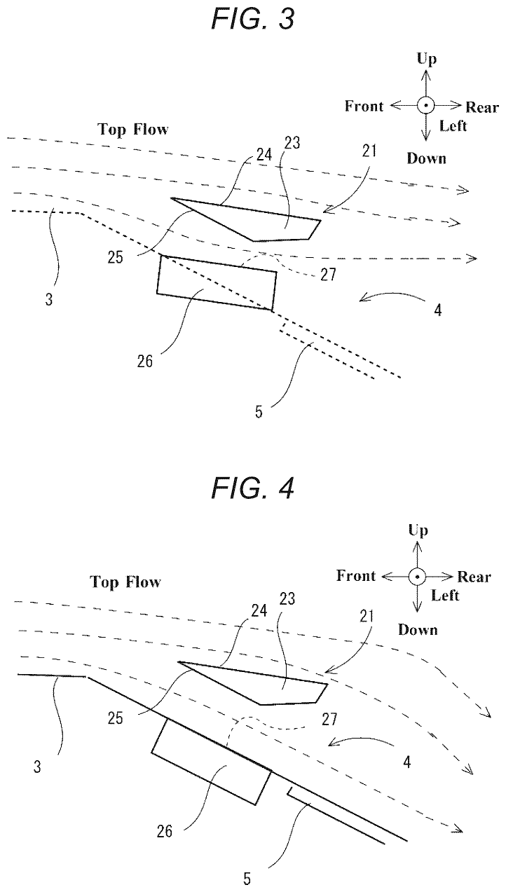

FIG. 3 is a schematic diagram illustrating a state in which the kick member 26 in FIG. 2 protrudes from the vehicle body rear surface 4.

FIG. 4 is a schematic diagram illustrating a state in which the kick member 26 in FIG. 2 is stored in the vehicle body rear surface 4.

The roof spoiler member 21 includes left and right legs 22 and a flow guide plate 23 provided between the left and right legs 22.

The left and right legs 22 are fixed to and erected on left and right portions of the vehicle body 2, for example, on the vehicle body rear surface 4 above a rear window 5 of the vehicle body 2. Accordingly, the flow guide plate 23 disposed between the left and right legs 22 extend over the entire width of the vehicle body 2 along the vehicle width direction of the vehicle body 2. The flow guide plate 23 is disposed at a position behind a rear edge of the roof 3 and separated from the rear edge of the roof 3 and the vehicle body rear surface 4 of the vehicle body 2. As illustrated in FIGS. 3 and 4, a part of the overbody airflow over the roof 3 flows over and under the flow guide plate 23 of the roof spoiler member 21 and joins behind the flow guide plate 23.

The flow guide plate 23 of the roof spoiler member 21 includes a lower surface 25 and an upper surface 24. The lower surface 25 and the upper surface 24 together with a rear surface 29 form a closed cross section. The lower surface 25 and the upper surface 24 are coupled to each other at an inflow end 51 of the flow guide plate 23. The lower surface 25 extends downward from the inflow end 51. The lower surface 25 is a surface closer to the rear window 5 than the upper surface 24 is. The upper surface 24 is a surface that extends rearward from the inflow end 51 above the lower surface 25. The upper surface 24 is an upper surface with respect to the lower surface 25 of the vehicle body 2 in an up-down direction.

The upper surface 24 has a flat shape at a first depression angle θ1 that inclines downward and rearward. The upper surface 24 may have a flat surface that is curved in the vehicle width direction of the vehicle body 2. The upper surface 24 of the flow guide plate 23 of the roof spoiler member 21 is provided at the first depression angle θ1. Airflow over the flow guide plate 23 can flow rearward from the inflow end 51 of the flow guide plate 23 along the upper surface 24 and flow from an outflow end 54 on the flow guide plate 23 toward the rear of the flow guide plate 23 of the roof spoiler member 21.

The lower surface 25 includes a first lower surface 25a and a second lower surface 25b. The first lower surface 25a faces the rear window 5. The second lower surface 25b is a surface that extends rearward from a position 52 at a rear edge of the first lower surface 25a. In FIG. 2, the second lower surface 25b has a small elevation angle. The second lower surface 25b may have a smaller depression angle than the first lower surface 25a. The lower surface 25 with these shapes is a downward-convex curved surface. Airflow under the flow guide plate 23 can flow from the inflow end 51 of the flow guide plate 23 along the first lower surface 25a, flow along the second lower surface 25b, and flow from an outflow end 53 below the flow guide plate 23 toward the rear of the flow guide plate 23 of the roof spoiler member 21. The first lower surface 25a and the second lower surface 25b may be curved in the vehicle width direction of the vehicle body 2.

In this manner, the airflow flowing toward the flow guide plate 23 can be divided into upper airflow and lower airflow by the flow guide plate 23 of the roof spoiler member 21 at the inflow end 51 of the flow guide plate 23, the upper airflow and the lower airflow can flow along the upper surface 24 and the lower surface 25, and the upper airflow and the lower airflow can join behind the flow guide plate 23 of the roof spoiler member 21. A creepage distance of the lower surface 25 of the roof spoiler member 21 is longer than that of the upper surface 24. As a result, the flow guide plate 23 of the roof spoiler member 21 can generate a down force.

### Example of Configuration of Kick Member

The kick member 26 is provided on the vehicle body 2 so as to protrude from the vehicle body rear surface 4 above the rear window 5 of the vehicle body 2 and between the left and right legs 22 of the roof spoiler member 21. The kick member 26 extends between the left and right legs 22 of the roof spoiler member 21 in the vehicle width direction of the vehicle body 2. The kick member 26 includes a facing surface 27 extending along the vehicle width direction so as to face the lower surface 25 of the flow guide plate 23 of the roof spoiler member 21 over a substantially entire width.

Here, the rear window 5 of the vehicle body rear surface 4 in FIG. 2 is provided such that an outer surface of the rear window 5 has a second depression angle θ2 that inclines downward and rearward. The vehicle body rear surface 4 on the upper side of the rear window 5 is provided at the same second depression angle θ2 as that of the rear window 5. The vehicle body rear surface 4 following from the rear edge of the roof 3 extends to the rear window 5 at the second depression angle θ2. The first depression angle θ1 is a depression angle smaller than the second depression angle θ2.

The kick member 26, which is elongated in the vehicle width direction, is movable with respect to the vehicle body 2. In the present embodiment, the kick member 26 is pivotable around a shaft 28 in the vehicle width direction, which is provided at an upper portion of the kick member 26.

The pivotable kick member 26 is rotatable between a storage state in FIG. 4 in which the kick member 26 is stored such that the facing surface 27 is substantially flush with the vehicle body rear surface 4, and a protruding state in FIG. 3 in which the facing surface 27 protrudes from the vehicle body rear surface 4 so as to approach the flow guide plate 23 of the roof spoiler member 21.

In a state of being stored in the vehicle body 2, the facing surface 27 of the kick member 26 has a surface shape that does not provide any step between the facing surface 27 and the vehicle body rear surface 4 around the kick member 26, as illustrated in FIG. 4. The facing surface 27 may have a planar shape.

Since the kick member 26 has the second control depression angle, at least a part of the airflow under the flow guide plate 23 of the roof spoiler member 21 flows downward along the rear window 5.

The kick member 26 protrudes from the vehicle body rear surface 4 as illustrated in FIG. 3 by rotating around the shaft 28 in the vehicle width direction which is provided at the upper portion of the kick member 26. In the protruding state, an upper edge of the kick member 26 does not protrude from the vehicle body rear surface 4. The kick member 26 protrudes from the vehicle body rear surface 4 due to an oblique posture in which a protruding amount gradually increases from an upper portion to a lower portion of the kick member 26. Accordingly, airflow under the flow guide plate 23 of the roof spoiler member 21 flows along the facing surface 27 of the kick member 26 protruding from the vehicle body rear surface 4 and flows rearward toward the rear side of the vehicle body 2.

### Example of Control System of Kick Member

The rear camera 16 captures an image of the vehicle body rear surface 4 of the vehicle body 2. The rear camera 16 may be provided facing downward, for example, on the flow guide plate 23 of the roof spoiler member 21. The rear camera 16 may also be provided facing rearward in a vehicle cabin of the vehicle body 2. The rear camera 16 may be a monocular camera or a 360° camera.

The actuator 12 rotationally drives the kick member 26 between the second control depression angle and the first control depression angle. The actuator 12 holds the kick member 26 in a rotationally driven posture. The actuator 12 may, for example, directly drive the kick member 26 to rotate, or may drive the kick member 26 to rotate using a rod or the like that pushes the kick member 26 up from below.

The operation member 13 is a member provided in a vehicle cabin, which is not illustrated, of the vehicle body 2 and operated by an occupant such as a driver who drives the vehicle 1.

The control device 14 controls a movement of the kick member 26. The rear camera 16, the actuator 12, and the operation member 13 are coupled to the control device 14. Based on an image captured by the rear camera 16, the control device 14 determines whether snow adheres to the vehicle body rear surface 4. The control device 14 operates the actuator 12 according to a determination result. Accordingly, the kick member 26 is controlled between the protruding state in FIG. 3 and the storage state in FIG. 4.

### Example of Control State of Movement of Kick Member

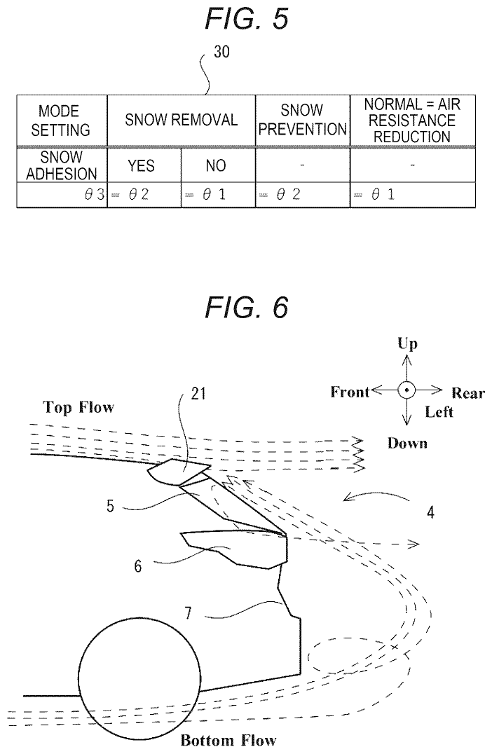

FIG. 5 is a table 30 illustrating an example of a relationship between a mode setting of the vehicle 1 and a content of the control of the kick member 26 in the embodiment.

FIG. 5 illustrates, as the mode setting of the vehicle 1, a normal mode for reducing the air resistance of the vehicle body 2, a snow removal mode, and a snow prevention mode. The table 30 in FIG. 5 may be recorded in a memory, which is not illustrated, of the control device 14.

Here, the snow removal mode is a mode in which, when snow adheres to the vehicle body rear surface 4, the snow falls off from the vehicle body rear surface 4.

The snow prevention mode is a mode to prevent snow adhesion to the vehicle body rear surface 4.

These mode settings for the vehicle 1 may be set by an operation of an occupant.

In the example illustrated in FIG. 5, when the normal mode is set, the control device 14 operates the actuator 12 to rotationally drive the kick member 26 such that a depression angle θ3 of the facing surface 27 becomes the first control depression angle same as the first depression angle θ1.

When the snow prevention mode is set, the control device 14 operates the actuator 12 to rotationally drive the kick member 26 such that the depression angle θ3 of the facing surface 27 becomes the second control depression angle same as the second depression angle θ2.

When the snow removal mode is set, the control device 14 acquires an image captured by the rear camera 16 and determines whether snow adheres to the vehicle body rear surface 4. The control device 14 operates the actuator 12 according to the determination result to move the kick member 26 between the first control depression angle and the second control depression angle.

### Example of Airflow When Kick Member Protrudes from Vehicle Body Rear Surface

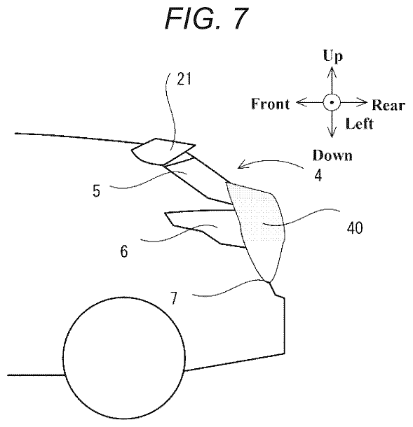

FIG. 6 is a schematic diagram illustrating airflow over the vehicle body rear surface 4 in the normal mode in which the air resistance is reduced.

In FIG. 6, the kick member 26 is controlled to the first control depression angle as illustrated in FIG. 3, and protrudes from the vehicle body rear surface 4 below the roof spoiler member 21. Here, the first control depression angle is the same as the first depression angle θ1 of the upper surface 24 of the roof spoiler member 21.

In FIG. 6, a lower rear surface 7, which is a part below the rear window 5, of the vehicle body rear surface 4 as a whole has a steeper inclination than the rear window 5. A rear light 6 is provided under the rear window 5.

In this case, the overbody airflow over the roof 3 is divided into upper airflow and lower airflow in the flow guide plate 23 of the roof spoiler member 21, then flows toward the rear of the vehicle body 2 along the upper surface 24 and the lower surface 25 of the flow guide plate 23, and joins behind the flow guide plate 23. The airflow under the flow guide plate 23 of the roof spoiler member 21 is less likely to flow downward along the rear window 5.

As a result, on the vehicle body rear surface 4, the underbody airflow under the vehicle body 2 reaches a rear end of the vehicle body 2 and then blows up toward the rear side of the vehicle body rear surface 4, which is at a negative pressure. In the example in FIG. 6, the underbody airflow flows upward along the vehicle body rear surface 4 and blows up toward the vicinity of an upper edge of the rear window 5. The underbody airflow blowing up to the vicinity of the upper edge of the rear window 5 then blows down along an outer surface of the rear window 5 and flows toward the rear of the vehicle body 2.

### Example of Snow Adhesion to Vehicle Body Rear Surface

FIG. 7 is a schematic diagram illustrating a state in which snow adheres to the vehicle body rear surface 4 in the normal mode.

FIG. 7 illustrates a state of the vehicle body rear surface 4 after traveling during snowfall or traveling on a snowy road in the state of FIG. 6.

As illustrated in FIG. 7, a snow lump 40 adheres to the vehicle body rear surface 4. The snow lump 40 adheres to a range from the rear window 5 of the vehicle body rear surface 4 to the lower rear surface 7 below the rear window 5. The snow lump 40 on the vehicle body rear surface 4 is formed when snow blown up by the underbody airflow hits the vehicle body rear surface 4 one after another and accumulates on the vehicle body rear surface 4.

For example, since the lower rear surface 7, which is below the rear window 5, of the vehicle body rear surface 4 in FIG. 7 has a larger depression angle than the rear window 5, the snow blows upward with the same lifting momentum. The lower rear surface 7 is less likely to hinder blowing up of snow. The snow is likely to be blown up to reach a height of the rear window 5.

When the snow adheres to the rear window 5 in this manner, rearward visibility from inside the vehicle decreases. When the snow adheres to the rear light 6, visibility of the vehicle body 2 from behind decreases. It is difficult for a driver in a following vehicle to check a lighting state of the rear light 6.

### Example of Airflow When Kick Member Is Stored in Vehicle Body Rear Surface

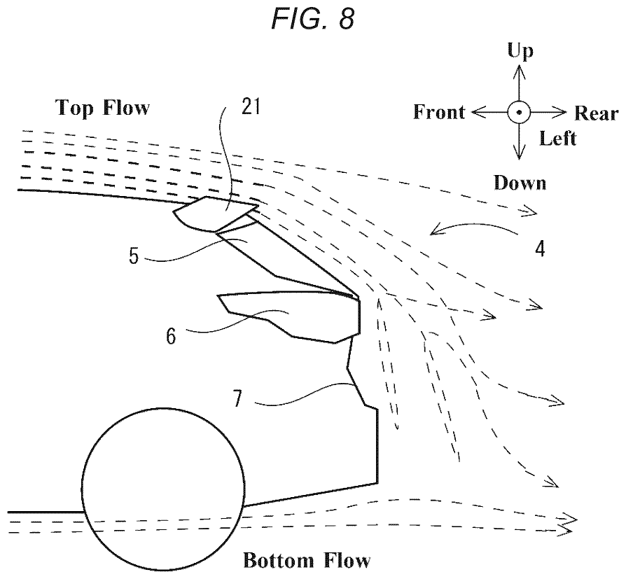

FIG. 8 is a schematic diagram illustrating airflow over the vehicle body rear surface 4 in the snow removal mode.

FIG. 8 illustrates a state after the kick member 26 is controlled and stored at the second control depression angle as illustrated in FIG. 4 and the vehicle travels in the state of FIG. 7. In this case, the vehicle 1 may travel during snowfall or may travel on a snowy road. The second control depression angle is the same as the second depression angle θ2 of the outer surface of the rear window 5.

In this case, the overbody airflow over the roof 3 is divided into upper airflow and lower airflow of the flow guide plate 23 of the roof spoiler member 21. The airflow under the flow guide plate 23 of the roof spoiler member 21 flows downward along the vehicle body rear surface 4 and the rear window 5, rather than flowing along the lower surface 25 of the flow guide plate 23 of the roof spoiler member 21. The downward airflow running downward along the rear window 5 continuously blows against the snow adhering to the vehicle body rear surface 4 of the vehicle body 2. As a result, the snow adhering to the vehicle body rear surface 4 of the vehicle body 2 may be detached from the vehicle body rear surface 4 of the vehicle body 2 and fall off. The rearward visibility from inside the vehicle is recovered. Visibility of the rear light 6 from behind is also recovered.

### Mode Control Example

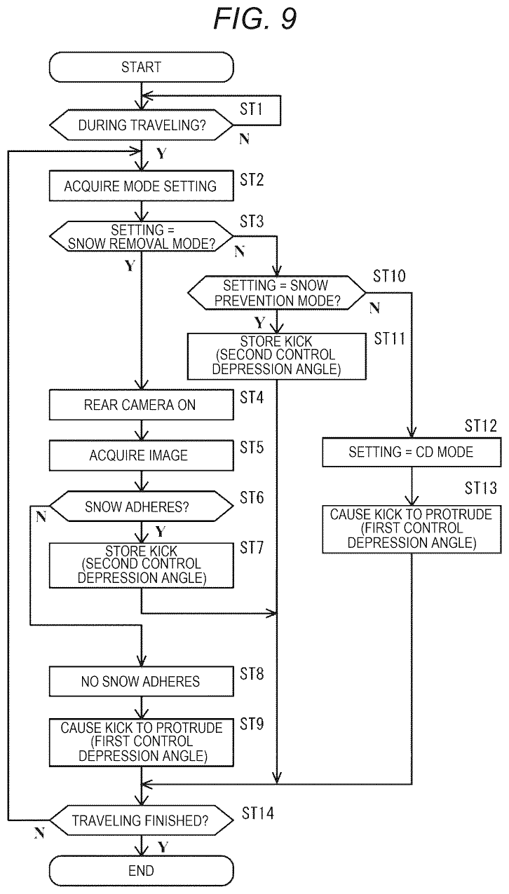

FIG. 9 is a flowchart illustrating an example of control of the kick member 26 that is executed by the control device 14 in FIG. 2.

The control device 14 repeatedly executes control of the kick member 26 in FIG. 9.

In step ST1, the control device 14 determines whether the vehicle 1 is traveling.

The control device 14 acquires, for example, a state of an engine start button of the vehicle 1 and an operation state of an ignition switch, which are provided on the operation member 13. In this case, when the engine start button is operated to an OFF state, the control device 14 determines that the vehicle 1 is not traveling, and repeats the process. When the ignition switch is operated in a state other than an ON state, the control device 14 determines that the vehicle 1 is not traveling, and repeats the process.

When the engine start button is operated in an ON state or when the ignition switch is operated in the ON state, the vehicle 1 is determined to be traveling, and the process proceeds to step ST2.

In step ST2, the control device 14 acquires information on modes to be set for the operation member 13. Examples of the modes to be set for the vehicle 1 include the air resistance reduction mode, the snow removal mode, and the snow prevention mode, as illustrated in FIG. 5. These modes are usable for controlling the kick member 26. An occupant, such as a driver of the vehicle 1, operates the operation member 13 at his or her own discretion to set one or more of three modes, that is, the air resistance reduction mode, the snow removal mode, and the snow prevention mode, to the vehicle 1.

The mode to be set for the vehicle 1 may be a mode in other categories. For example, certain vehicles 1 can be set to a rough road travel mode, a sports mode, and a high speed driving mode. In this case, the control device 14 may fixedly associate the air resistance reduction mode, the snow removal mode, or the snow prevention mode with each mode in advance, and convert the mode acquired in the process of step ST2 into one of the three modes.

In step ST3, the control device 14 determines whether the set mode acquired in step ST2 is the snow removal mode. When the set mode is not the snow removal mode, the control device 14 advances the process to step ST10. When the set mode is the snow removal mode, the control device 14 advances the process to step ST4.

From step ST4, the control device 14 starts movement control of the kick member 26 for the snow removal mode.

When the snow removal mode is set, the control device 14 moves the kick member 26 between the first control depression angle and the second control depression angle according to a result of determining whether snow adheres based on an image captured by the rear camera 16.

In step ST5, the control device 14 acquires a latest image from the rear camera 16 which captures an image of the vehicle body rear surface 4.

In step ST6, the control device 14 analyzes the image acquired in step ST5 and determines whether snow adheres to the vehicle body rear surface 4.

For example, when the snow adheres to the vehicle body rear surface 4 as illustrated in FIG. 7, the control device 14 determines that the snow adheres to the vehicle body rear surface 4, and advances the process to step ST7.

When a ratio of the number of snow-colored pixels to the number of pixels of the captured vehicle body rear surface 4 is more than a predetermined threshold, the control device 14 may determine that the snow adheres to the vehicle body rear surface 4. Alternatively, the control device 14 may determine that the snow adheres to the vehicle body rear surface 4 when the number of pixels of a color of the rear window 5 of the vehicle body rear surface 4 or the number of pixels of a color of a rear lamp that are captured is equal to or less than a predetermined ratio with respect to the total number of pixels thereof when no snow adheres. Here, the number of pixels corresponds to an imaging area.

On the other hand, when the control device 14 does not determine that the snow adheres to the vehicle body rear surface 4, the control device 14 advances the process to step ST8.

In step ST7, the control device 14 controls the kick member 26 to the second control depression angle by using the actuator 12. Accordingly, the kick member 26 is stored in the vehicle body rear surface 4 as illustrated in FIG. 4. The airflow around the vehicle body 2 is as illustrated in FIG. 8. Therefore, for example, as illustrated in FIG. 7, snow adhering to the vehicle body rear surface 4 falls off from the vehicle body rear surface 4 due to airflow flowing from top to bottom along the vehicle body rear surface 4.

Thereafter, the control device 14 advances the process to step ST14.

From step ST8, the control device 14 starts processes when no snow adheres.

In step ST9, the control device 14 controls the kick member 26 to the first control depression angle by using the actuator 12. Accordingly, the kick member 26 protrudes from the vehicle body rear surface 4, as illustrated in FIG. 3. The airflow around the vehicle body 2 is as illustrated in FIG. 6. An air resistance of the vehicle body 2 can be reduced.

Thereafter, the control device 14 advances the process to step ST14.

In step ST10, the control device 14 determines whether the set mode acquired in step ST2 is the snow prevention mode. When the set mode is not the snow prevention mode, the control device 14 advances the process to step ST12. When the set mode is the snow prevention mode, the control device 14 advances the process to step ST11.

In step ST11, the control device 14 controls the kick member 26 to the second control depression angle by using the actuator 12. Accordingly, the kick member 26 is stored in the vehicle body rear surface 4 as illustrated in FIG. 4. The airflow around the vehicle body 2 is as illustrated in FIG. 8. In this case, a part of the overbody airflow always flows from top to bottom along the vehicle body rear surface 4. Therefore, the snow is less likely to adhere to the vehicle body rear surface 4, for example, as illustrated in FIG. 7.

Thereafter, the control device 14 advances the process to step ST14.

From step ST12, the control device 14 starts a process in the normal mode.

In step ST13, the control device 14 controls the kick member 26 to the first control depression angle by using the actuator 12. Accordingly, the kick member 26 protrudes from the vehicle body rear surface 4, as illustrated in FIG. 3. The airflow around the vehicle body 2 is as illustrated in FIG. 6. The air resistance of the vehicle body 2 can be reduced.

Thereafter, the control device 14 advances the process to step ST14.

In step ST14, the control device 14 determines whether the traveling of the vehicle 1 is finished.

The control device 14 may determine whether the traveling of the vehicle 1 is finished based on, for example, a state of the engine start button of the vehicle 1 and the operation state of the ignition switch provided on the operation member 13. When the engine start button or the ignition switch is in the OFF state, the control device 14 determines that the traveling of the vehicle 1 is finished, and ends the control.

Otherwise, the control device 14 determines that the traveling of the vehicle 1 is not finished, and returns the process to step ST2. Until the control device 14 determines that the traveling of the vehicle 1 is finished, the control device 14 repeats the processes in steps ST2 to ST14.

When the occupant operates the operation member 13 to change the mode setting of the vehicle 1 while the vehicle 1 is traveling, the control device 14 can execute a process corresponding to the changed mode setting in steps ST2 to ST14.

As a result of the kick member 26 protruding from the vehicle body rear surface 4 and the vehicle traveling in the snow removal mode, when snow adheres to the vehicle body rear surface 4 as illustrated in the example in FIG. 7, the control device 14 can store the kick member 26 and remove the snow adhering to the vehicle body rear surface 4 in a subsequent process. When the vehicle body rear surface 4 becomes free of snow, the control device 14 can determine that no snow adheres to the vehicle body rear surface 4 based on the image of the rear camera 16 and causes the kick member 26 to protrude from the vehicle body rear surface 4. Accordingly, the air resistance of the vehicle body 2 can be reduced. Under the setting of the snow removal mode, the control device 14 basically causes the kick member 26 to protrude from the vehicle body rear surface 4 to reduce the air resistance of the vehicle body 2, and when snow adheres to the vehicle body rear surface 4 during the traveling, the control device 14 can store the kick member 26 and remove snow adhering to the vehicle body rear surface 4. After the control device 14 removes the snow adhering to the vehicle body rear surface 4, the kick member 26 is again protruded from the vehicle body rear surface 4, thereby reducing the air resistance of the vehicle body 2 and enabling the vehicle to travel.

### Advantages of Embodiments

As described above, in the present embodiment, the vehicle body 2 is provided with the roof spoiler member 21 and the kick member 26. The roof spoiler member 21 is fixed to the vehicle body 2 at the rear side of the roof 3 of the vehicle body 2 of the vehicle 1 so as to be separated from the roof 3 of the vehicle body 2 and the vehicle body rear surface 4. The kick member 26 protrudes from the vehicle body rear surface 4 of the vehicle body 2 above the rear window 5 of the vehicle body 2. The kick member 26 includes the facing surface 27 that faces the lower surface 25 of the roof spoiler member 21.

When removing snow adhering to the vehicle body rear surface 4 or when preventing snow adhesion to the vehicle body rear surface 4, the kick member 26 moves from a state of protruding from the vehicle body rear surface 4 and is stored in the vehicle body rear surface 4.

In this manner, the kick member 26 protrudes from the vehicle body rear surface 4 such that the depression angle θ3 of the facing surface 27 becomes the first control depression angle. Accordingly, the roof spoiler member 21 and the kick member 26 can cause the overbody airflow over the roof 3 of the vehicle body 2 to flow from over and under the roof spoiler member 21 toward the rear of the vehicle body 2 while maintaining a flow over the roof 3. As a result, the air resistance of the vehicle body 2 is reduced.

When removing or preventing snow adhering to the vehicle body rear surface 4 of the vehicle body 2, the kick member 26 moves to reduce a protrusion amount from the vehicle body rear surface 4 and is stored in the vehicle body rear surface 4. The kick member 26 is stored in the vehicle body rear surface 4 such that at least a part of the airflow under the roof spoiler member 21 can flow toward the rear window 5 and flow downward along the rear window 5 of the vehicle body rear surface 4. As a result, the snow adhering to the vehicle body rear surface 4 of the vehicle body 2 is likely to be detached from the vehicle body rear surface 4 of the vehicle body 2 and falls off by the downward airflow flowing along the rear window 5.

In this manner, in the present embodiment, the kick member 26 which faces the lower surface 25 of the roof spoiler member 21 moves on the vehicle body rear surface 4 of the vehicle body 2. Accordingly, in the present embodiment, both reducing the air resistance by the roof spoiler member 21 and preventing the snow adhesion to the vehicle body rear surface 4 of the vehicle body 2 can be achieved. Reducing the air resistance and preventing the snow adhesion to the vehicle body rear surface 4 use opposing countermeasures from an aerodynamical point of view. However, in the present embodiment, both of these countermeasures can be satisfied by providing the kick member 26 facing the roof spoiler member 21 and moving the kick member 26.

For example, in the vehicle body 2 according to the embodiment, the rear window 5 is provided on the vehicle body rear surface 4 at a depression angle that is inclined upward toward a front of the vehicle body 2, and the lower rear surface 7, which is below the rear window 5, of the vehicle body rear surface 4 as a whole has a steeper inclination than the rear window 5. In this case, if the air resistance of the vehicle body 2 is reduced by the roof spoiler member 21, snow is likely to adhere to accumulate on the vehicle body rear surface 4, such as the rear window 5. In the present embodiment, even in the vehicle body 2 having the vehicle body rear surface 4 having such a shape to which snow is likely to adhere, it is possible to achieve both reducing the air resistance and preventing the snow adhesion to the vehicle body rear surface 4.

In the present embodiment, in the normal mode in which the air resistance of the vehicle body 2 is reduced, the kick member 26 protrudes from the vehicle body rear surface 4 such that the depression angle θ3 of the facing surface 27 becomes the first control depression angle that is the same depression angle as the first depression angle θ1. Here, the first depression angle θ1 is a depression angle of the upper surface 24 of the roof spoiler member 21. Accordingly, even when the overbody airflow over the roof 3 of the vehicle body 2 is divided into upper airflow and lower airflow of the roof spoiler member 21 and flows toward the rear of the vehicle body 2, the upper airflow and the lower airflow are likely to join together on the rear side of the roof spoiler member 21 while maintaining a flow over the roof 3 of the vehicle body 2. Vortexes are less likely to be generated on the rear side of the roof spoiler member 21. As a result, the overbody airflow over the roof 3 flows through the roof spoiler member 21 while maintaining the flow over the roof 3 and is likely to be separated toward the rear of the vehicle body 2. Reduction of the air resistance of the vehicle body 2 is further improved.

In the snow removal mode in which snow adhering to the vehicle body rear surface 4 of the vehicle body 2 is removed, the kick member 26 moves such that the depression angle θ3 of the facing surface 27 is the second control depression angle that is equal to the second depression angle θ2. Here, the second depression angle θ2 is a depression angle of the outer surface of the rear window 5. When the facing surface 27 has a depression angle same as that of the second depression angle θ2, the kick member 26 can be basically stored in the vehicle body rear surface 4 such that the kick member 26 does not protrude from the vehicle body rear surface 4. Accordingly, airflow under the roof spoiler member 21 is likely to flow downward along the vehicle body rear surface 4 and the rear window 5. Airflow under the roof spoiler member 21 is less likely to flow in a direction separated from the vehicle body rear surface 4 and the rear window 5 to the rear side. As a result, snow adhering to the rear window 5 of the vehicle body rear surface 4 of the vehicle body 2 is likely to be detached from the vehicle body rear surface 4 and the rear window 5 of the vehicle body 2 and falls off due to the airflow flowing from top to bottom along the vehicle body rear surface 4 and the rear window 5. Large snow lumps are less likely to remain on the vehicle body rear surface 4 and the rear window 5.

The vehicle 1 with the kick member 26 which moves under such a depression angle condition can achieve both reducing the air resistance by the roof spoiler member 21 and preventing snow adhesion to the vehicle body rear surface 4 of the vehicle body 2.

On the other hand, for example, when the facing surface 27 of the kick member 26 is at a depression angle larger than the first depression angle θ1 of the upper surface 24 of the roof spoiler member 21, after the overbody airflow over the roof 3 of the vehicle body 2 is divided into upper airflow and lower airflow of the roof spoiler member 21, a difference occurs between the upper airflow and the lower airflow, and the upper airflow and the lower airflow are less likely to join together on the rear side of the roof spoiler member 21 while maintaining a flow over the roof 3. Vortex flows are more likely to be generated around the roof spoiler member 21. Airflow under the roof spoiler member 21 is more likely to flow downward of the vehicle body 2. When these situations occur, the air resistance of the vehicle body 2 increases.

When the facing surface 27 of the kick member 26 has a depression angle smaller than the second depression angle θ2 of the outer surface of the rear window 5, a part of the overbody airflow over the roof 3 of the vehicle body 2 is more likely to flow toward a position separated from the vehicle body rear surface 4 and the rear window 5 to the rear side, even when the lower airflow under the roof spoiler member 21 flows downwardly of the vehicle body 2. In this manner, the airflow that is separated from the vehicle body rear surface 4 and the rear window 5 to the rear side is less likely to detach the snow adhering to the vehicle body rear surface 4 and the rear window 5.

In the present embodiment, the control device 14 moves the kick member 26. For example, the control device 14 determines whether snow adheres to the vehicle body rear surface 4 based on an image obtained by a camera provided on the vehicle body 2 to capture an image of the vehicle body rear surface 4. When no snow adheres to the vehicle body rear surface 4, the control device 14 causes the kick member 26 to protrude from the vehicle body rear surface 4 such that the depression angle θ3 of the facing surface 27 becomes the first control depression angle. Accordingly, the air resistance of the vehicle 1 is reduced.

On the other hand, when snow adheres to the vehicle body rear surface 4, the control device 14 moves the kick member 26 such that the depression angle θ3 of the facing surface 27 becomes the second control depression angle. Accordingly, the snow adhering to the vehicle body rear surface 4 whose image is captured by the camera can be detached from the vehicle body rear surface 4.

In the present embodiment, one of an air resistance reduction mode for normal traveling, a snow removal mode, and a snow prevention mode can be set for the vehicle 1. The control device 14 acquires the set mode settings as setting information of the kick member 26. When the air resistance reduction mode for normal traveling is set, the kick member 26 protrudes from the vehicle body rear surface 4 such that the depression angle θ3 of the facing surface 27 becomes the first control depression angle. Accordingly, the vehicle 1 can continue traveling with the air resistance reduced.

In contrast, when the snow prevention mode is set, the control device 14 moves the kick member 26 such that the depression angle θ3 of the facing surface 27 becomes the second control depression angle. Accordingly, the vehicle 1 can continue traveling without snow adhering to the vehicle body rear surface 4.

When the snow removal mode is set, the control device 14 moves the kick member 26 between the first control depression angle and the second control depression angle according to a result of determining whether snow adheres based on an image captured by the camera. Accordingly, the vehicle 1 normally travels with a reduced air resistance, and when the snow adheres to the vehicle body rear surface 4, the snow is removed and the vehicle can continue traveling. The driver who drives the vehicle 1 and a driver who drives the following vehicle can continue traveling without being disturbed by the snow adhering to the vehicle body rear surface 4 of the vehicle 1 and without being affected by a decrease in visibility due to the snow adhesion to the vehicle body rear surface 4 of the vehicle 1.

### Modified Example

The above embodiment is a mere example of the disclosure. It is noted that the disclosure is not limited to the above embodiment. Various modifications and changes may be made without departing from the gist of the disclosure.

### Modified Example of Control of Kick Member

In the present embodiment, in the normal mode in which the air resistance of the vehicle body 2 is reduced, the kick member 26 protrudes from the vehicle body rear surface 4 such that the depression angle θ3 of the facing surface 27 becomes the first control depression angle that is equal to the first depression angle θ1.

Alternatively, for example, in the normal mode in which the air resistance of the vehicle body 2 is reduced, the kick member 26 may protrude from the vehicle body rear surface 4 such that the depression angle θ3 of the facing surface 27 becomes the first control depression angle that is equal to or smaller than the first depression angle θ1. In this case as well, most of the overbody airflow over the roof 3 of the vehicle body 2 flows from over and under the roof spoiler member 21 toward the rear of the vehicle body 2, and can be expected to easily join together on the rear side of the roof spoiler member 21 while maintaining a flow over the roof 3 of the vehicle body 2. It is expected that vortices are less likely to be generated around the roof spoiler member 21. As a result, the overbody airflow over the roof 3 is expected to flow toward the rear of the vehicle body 2 while maintaining a flow over the roof 3. It can be expected to improve reduction of the air resistance of the vehicle body 2.

In the above-described embodiment, in the snow removal mode in which snow adhering to the vehicle body rear surface 4 of the vehicle body 2 is removed, the kick member 26 moves such that the depression angle θ3 of the facing surface 27 becomes the second control depression angle that is equal to the second depression angle θ2. In this case as well, it is expected that a part of the airflow under the roof spoiler member 21 flows downward along the vehicle body rear surface 4, and further flow downward along the outer surface of the rear window 5. The airflow is less likely to flow from top to bottom when the airflow is separated from the vehicle body rear surface 4, such as the rear window 5, to the rear side. As a result, snow adhering to the rear window 5 of the vehicle body rear surface 4 of the vehicle body 2 can be detached from the vehicle body rear surface 4 of the vehicle body 2 and fall off. It is expected that a large snow lump is less likely to remain on the vehicle body rear surface 4 such as the rear window 5.

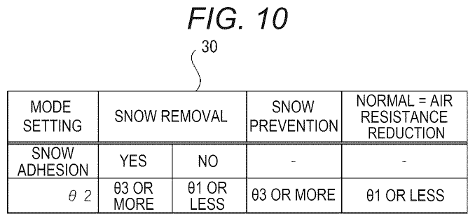

FIG. 10 is the table 30 illustrating an example of a relationship between a mode setting of the vehicle 1 and a content of the control of the kick member 26 in the modified example.

FIG. 10 illustrates, as the mode setting of the vehicle 1, a normal mode for reducing the air resistance of the vehicle body 2, a snow removal mode, and a snow prevention mode.

In the example illustrated in FIG. 10, when the normal mode is set, the control device 14 operates the actuator 12 to rotationally drive the kick member 26 such that the depression angle θ3 of the facing surface 27 becomes the first control depression angle that is equal to or less than the first depression angle θ1.

When the snow prevention mode is set, the control device 14 operates the actuator 12 to rotationally drive the kick member 26 such that the depression angle θ3 of the facing surface 27 becomes the second control depression angle that is equal to or greater than the second depression angle θ2.

When the snow removal mode is set, the control device 14 acquires an image captured by the rear camera 16 and determines whether snow adheres to the vehicle body rear surface 4. When snow adheres, the control device 14 operates the actuator 12 to rotationally drive the kick member 26 such that the depression angle θ3 of the facing surface 27 becomes the second control depression angle that is equal to or greater than the second depression angle θ2. When no snow adheres, the control device 14 operates the actuator 12 to rotationally drive the kick member 26 such that the depression angle θ3 of the facing surface 27 becomes the second control depression angle that is equal to or smaller than the first depression angle θ1.

When the depression angle θ3 of the facing surface 27 is equal to or less than the first depression angle θ1, the overbody airflow is likely to flow toward the rear of the vehicle body 2, in a manner similar to the case in which the depression angle θ3 of the facing surface 27 is the same as the first depression angle θ1.

When the depression angle θ3 of the facing surface 27 is equal to or greater than the second depression angle θ2, the overbody airflow is likely to flow along the vehicle body rear surface 4, in a manner similar to the case in which the depression angle θ3 of the facing surface 27 is the same as the second depression angle θ2. In this case, for example, even when an upper portion of the rear window 5 on the vehicle body rear surface 4 has a larger depression angle than the rear window 5, the kick member 26 can be stored in such a manner as to be flush with the upper portion. By storing the kick member 26 such that the facing surface 27 is flush with the vehicle body rear surface 4, a part of the overbody airflow can flow smoothly from top to bottom along the vehicle body rear surface 4.

In the above-described embodiment, the first control depression angle of the kick member 26 is the same as the first depression angle θ1 of the upper surface 24 of the roof spoiler member 21.

However, due to a design of the vehicle body 2 itself, the upper surface 24 of the roof spoiler member 21 may be delicately curved between a front edge and a rear edge of the roof spoiler member 21. In this case, the first control depression angle may be the same depression angle as a line segment connecting the front edge and the rear edge of the curved upper surface 24 of the roof spoiler member 21. The upper surface 24 of the roof spoiler member 21 may be curved in the vehicle width direction. In this case, the first control depression angle may be the same depression angle as the line segment connecting the front edge and the rear edge of the upper surface 24 of the roof spoiler member 21, for example, at the center in the vehicle width direction of the curved upper surface 24 of the roof spoiler member 21.

In the above-described embodiment, the second control depression angle of the kick member 26 is the same as the second depression angle θ2 of the outer surface of the rear window 5.

However, due to a design of the vehicle body 2 itself, the outer surface of the rear window 5 may be delicately curved between an upper edge and a lower edge of the outer surface of the rear window 5. In this case, the second control depression angle may be the same depression angle as the line segment connecting the upper edge and the lower edge of the curved outer surface of the rear window 5. An outer surface of the rear window 5 may be curved in the vehicle width direction. In this case, the second control depression angle may be the same depression angle as the line segment connecting the upper edge and the lower edge of the outer surface of the rear window 5, for example, at the center of the curved outer surface of the rear window 5 in the vehicle width direction.

In the above-described embodiment, the kick member 26 has a width corresponding to substantially the entire width in the vehicle width direction of the vehicle body 2.

Alternatively, for example, the kick member 26 may include multiple members arranged in the vehicle width direction of the vehicle body 2. The multiple members arranged in the vehicle width direction of the vehicle body 2 can change the shape of the facing surface 27 of the kick member 26 by individually controlling the respective depression angles. The multiple members arranged in the vehicle width direction of the vehicle body 2 can be changed to the shape such that, when the kick member 26 protrudes, the facing surface 27 is shaped to be suitable for the airflow under the roof spoiler member 21 to flow along the lower surface 25 of the roof spoiler member 21, and when the kick member 26 is stored, the facing surface 27 can be changed to have a shape suitable for storing the entire kick member 26 on the vehicle body rear surface 4.

In the above-described embodiment, the roof 3 is made substantially planar, and the rear edge of the roof 3 is directly joined to the vehicle body rear surface 4.

Alternatively, for example, a recessed groove may extend over the entire rear edge portion of the roof 3 in the vehicle width direction, and the recessed groove may be joined to the vehicle body rear surface 4. In this case, more of the overbody airflow over the roof 3 flows through the recessed groove portions to under the roof spoiler member 21 provided on the rear side of the roof 3. As illustrated in FIGS. 2 to 4, the roof spoiler member 21 may be provided at a height lower than the roof 3 in the whole flow guide plate 23, instead of being disposed at a height at which a part of the front side of the flow guide plate 23 protrudes upward from the roof 3.

In the above-described embodiment, the control device 14 determines whether snow adheres to the vehicle body rear surface 4 based on an image obtained by the rear camera 16.

The presence or absence of snow adhesion to the vehicle body rear surface 4 may be detected by, for example, light detection and ranging (LiDAR) provided at a rear portion of the vehicle body 2, a laser, a pressure sensor of the vehicle body rear surface 4, a temperature sensor, or the like, instead of being detected based on the image obtained by the rear camera 16. Further, the control device 14 may determine whether snow adheres to the vehicle body rear surface 4 based on detection by the vehicle sensors that detect a snow adhesion state on the vehicle body rear surface 4.

In the above-described embodiment, when the snow removal mode is set, the control device 14 moves to switch the kick member 26 between the first control depression angle and the second control depression angle.

Alternatively, for example, when the snow removal mode is set, the control device 14 may move the kick member 26 such that the kick member 26 is gradually switched between the first control depression angle and the second control depression angle.

In an embodiment of the disclosure, the vehicle body includes the roof spoiler member and the facing surface member. The roof spoiler member is fixed to the vehicle body at a rear side of a roof of the vehicle body of the vehicle so as to be separated from the roof of the vehicle body and the vehicle body rear surface. The facing surface member protrudes from a vehicle body rear surface of the vehicle body above the rear window of the vehicle body.

When snow adhering to the vehicle body rear surface is removed or when snow adhesion to the vehicle body rear surface is prevented, the facing surface member moves from a state of protruding from the vehicle body rear surface and is stored in the vehicle body rear surface. The facing surface member moves between a state of protruding from the vehicle body rear surface and a state of being stored in the vehicle body rear surface.

When reducing the air resistance of the vehicle body, such a facing surface member protrudes from the vehicle body rear surface. Accordingly, the roof spoiler member and the facing surface member can cause the airflow over the roof of the vehicle body to flow from over and under the roof spoiler member toward the rear of the vehicle body while maintaining the flow over the roof. As a result, the air resistance of the vehicle body is reduced.

When snow adhering to the vehicle body rear surface of the vehicle body is removed or when snow adhesion to the vehicle body rear surface is prevented, the facing surface member moves from a state of protruding from the vehicle body rear surface and is stored in the vehicle body rear surface. Airflow under the roof spoiler member flows downward along the rear window of the vehicle body rear surface. As a result, snow adhering to the vehicle body rear surface of the vehicle body is likely to be detached from the vehicle body rear surface of the vehicle body due to the downward airflow flowing along the rear window.

In this manner, in one embodiment of the disclosure, the facing surface member is provided movably and faces the lower surface of the roof spoiler member on the vehicle body rear surface of the vehicle body. Accordingly, in one embodiment according to the disclosure, both reducing the air resistance by the roof spoiler member and preventing the snow adhesion to the vehicle body rear surface of the vehicle body can be achieved. Reducing the air resistance and preventing the snow adhesion to the vehicle body rear surface use opposing countermeasures from an aerodynamical point of view, and in an embodiment of the disclosure, both functions can be satisfied.

1. A vehicle comprising:
a roof spoiler member fixed to a vehicle body of the vehicle at a rear side of a roof of the vehicle body so as to be separated from the roof of the vehicle body and a vehicle body rear surface; and
a facing surface member provided on the vehicle body, the facing surface member being configured to move between a state of protruding from the vehicle body rear surface above a rear window of the vehicle body and a state of being stored in the vehicle body, wherein
the facing surface member is configured to, when removing snow adhering to the vehicle body rear surface or when preventing snow adhesion to the vehicle body rear surface, move from the state of protruding from the vehicle body rear surface toward the state of being stored in the vehicle body rear surface.

2. The vehicle according to claim 1, wherein
the roof spoiler member comprises a lower surface and an upper surface,
the lower surface is a surface closer to the rear window than the upper surface is,
the upper surface is a surface on an upper side of the vehicle body with respect to the lower surface in an up-down direction,
the upper surface of the roof spoiler member is provided at a first depression angle,
an outer surface of the rear window is provided at a second depression angle,
the first depression angle is smaller than the second depression angle, and
the facing surface member
comprises a facing surface that faces the lower surface of the roof spoiler member,
is configured to, when reducing an air resistance of the vehicle body, protrude from the vehicle body rear surface such that a depression angle of the facing surface becomes a first control depression angle that is equal to or less than the first depression angle, and
is configured to, when removing snow adhering to the vehicle body rear surface or when preventing snow adhesion to the vehicle body rear surface, move such that the depression angle of the facing surface becomes a second control depression angle that is equal to or greater than the second depression angle, and be stored in the vehicle body rear surface.

3. The vehicle according to claim 2, wherein
the rear window is inclined upward toward a front of the vehicle body,
a lower rear surface, which is a part below the rear window, of the vehicle body rear surface of the vehicle body has a steeper inclination than the rear window,
the roof spoiler member and the facing surface member protruding at the first control depression angle cause airflow over the roof of the vehicle body to flow from over and under the roof spoiler member toward a rear of the vehicle body, and
the facing surface member set at the second control depression angle causes airflow under the roof spoiler member to flow downward along the rear window.

4. The vehicle according to claim 1, further comprising:
a control device configured to move the facing surface member; and
a vehicle sensor configured to detect a snow adhesion state on the vehicle body rear surface, wherein
the control device is configured to
determine whether snow adheres to the vehicle body rear surface based on detection by the vehicle sensor,
when no snow adheres to the vehicle body rear surface, cause the facing surface member to protrude from the vehicle body rear surface such that a depression angle of the facing surface becomes a first control depression angle, and
when the snow adheres to the vehicle body rear surface, move the facing surface member such that the depression angle of the facing surface becomes a second control depression angle.

5. The vehicle according to claim 2, further comprising:
a control device configured to move the facing surface member; and
a vehicle sensor configured to detect a snow adhesion state on the vehicle body rear surface, wherein
the control device is configured to
determine whether snow adheres to the vehicle body rear surface based on detection by the vehicle sensor,
when no snow adheres to the vehicle body rear surface, cause the facing surface member to protrude from the vehicle body rear surface such that a depression angle of the facing surface becomes a first control depression angle, and
when the snow adheres to the vehicle body rear surface, move the facing surface member such that the depression angle of the facing surface becomes a second control depression angle.

6. The vehicle according to claim 3, further comprising:
a control device configured to move the facing surface member; and
a vehicle sensor configured to detect a snow adhesion state on the vehicle body rear surface, wherein
the control device is configured to
determine whether snow adheres to the vehicle body rear surface based on detection by the vehicle sensor,
when no snow adheres to the vehicle body rear surface, cause the facing surface member to protrude from the vehicle body rear surface such that a depression angle of the facing surface becomes a first control depression angle, and
when the snow adheres to the vehicle body rear surface, move the facing surface member such that the depression angle of the facing surface becomes a second control depression angle.

7. The vehicle according to claim 4, wherein
the control device is configured to
acquire, as setting information of the facing surface member, one mode setting among an air resistance reduction mode for normal traveling, a snow removal mode, and a snow prevention mode,
when the air resistance reduction mode for the normal traveling is set, cause the facing surface member to protrude from the vehicle body rear surface such that the depression angle of the facing surface becomes the first control depression angle,
when the snow prevention mode is set, move the facing surface member such that the depression angle of the facing surface becomes the second control depression angle, and
when the snow removal mode is set, move the facing surface member between the first control depression angle and the second control depression angle according to a result of determining whether snow adheres based on an image obtained by the vehicle sensor.

8. The vehicle according to claim 5, wherein
the control device is configured to
acquire, as setting information of the facing surface member, one mode setting among an air resistance reduction mode for normal traveling, a snow removal mode, and a snow prevention mode,
when the air resistance reduction mode for the normal traveling is set, cause the facing surface member to protrude from the vehicle body rear surface such that the depression angle of the facing surface becomes the first control depression angle,
when the snow prevention mode is set, move the facing surface member such that the depression angle of the facing surface becomes the second control depression angle, and
when the snow removal mode is set, move the facing surface member between the first control depression angle and the second control depression angle according to a result of determining whether snow adheres based on an image obtained by the vehicle sensor.

9. The vehicle according to claim 6, wherein
the control device is configured to
acquire, as setting information of the facing surface member, one mode setting among an air resistance reduction mode for normal traveling, a snow removal mode, and a snow prevention mode,
when the air resistance reduction mode for the normal traveling is set, cause the facing surface member to protrude from the vehicle body rear surface such that the depression angle of the facing surface becomes the first control depression angle,
when the snow prevention mode is set, move the facing surface member such that the depression angle of the facing surface becomes the second control depression angle, and
when the snow removal mode is set, move the facing surface member between the first control depression angle and the second control depression angle according to a result of determining whether snow adheres based on an image obtained by the vehicle sensor.

10. The vehicle according to claim 4, wherein the control device is configured to move the facing member when the vehicle is traveling.

11. The vehicle according to claim 5, wherein the control device is configured to move the facing member when the vehicle is traveling.

12. The vehicle according to claim 6, wherein the control device is configured to move the facing member when the vehicle is traveling.
